(19) United States
(12) Patent Application Publication
(10) Pub. No.: US 2025/0211296 A1
(43) Pub. Date: Jun. 26, 2025

(54) SKYWAVE MASSIVE MIMO BEAM STRUCTURE PRECODING-BASED TRANSMISSION METHOD AND SYSTEM THEREOF

(71) Applicant: Southeast University, Jiangsu (CN)

(72) Inventors: Xiqi GAO, Jiangsu (CN); Xianglong YU, Jiangsu (CN); Anan LU, Jiangsu (CN); Jinlin ZHANG, Jiangsu (CN); Hebing WU, Jiangsu (CN)

(21) Appl. No.: 18/851,361

(22) PCT Filed: Apr. 14, 2022
(86) PCT No.: PCT/CN2022/086916

§ 371 Date: Sep. 26, 2024

(30) Foreign Application Priority Data
Mar. 29, 2022 (CN) 202210317238.1

(51) Int. Cl. H04B 7/0456; H04B 7/06; H04W 72/044

(52) U.S. Cl. CPC H04B 7/0456; H04B 7/06952; H04W 72/046

(57) ABSTRACT

Disclosed by the present disclosure is a skywave massive MIMO beam structure precoding-based transmission method and a system thereof. The skywave massive MIMO communication base station generates a transmitted signal by utilizing a beam structure precoder, and implements a downlink precoding transmission. The beam structure precoder is composed of a low dimensional beam domain precoder of each user, a beam mapping module of each user, and a beam modulating module, the low dimensional beam domain precoder of each user is a precoder on a beam set of each user, the beam mapping module of each user is configured to map a low dimensional beam domain precoding signal of each user to a complete beam domain transmitted signal, the beam modulating module is configured to multiply a beam matrix by a beam domain transmitted signal vector, and the beam domain transmitted signal vector is a sum of beam domain transmitted signal vectors for each user. The present disclosure can solve the design and implementation complexity problem of skywave massive MIMO downlink precoding transmission, significantly improving the spectrum and power efficiency, transmission rate, and transmission distance of sky wave communication.

### TECHNICAL FIELD

The present disclosure relates to a field of skywave communication, and particularly relates to a skywave massive MIMO beam structure precoding-based transmission method and a system thereof.

### BACKGROUND

The Skywave communication commonly utilizes the short wave band ranging from 1.6 MHz to 30 MHz to implement a long-distance signal transmission of a plurality of thousand kilometers through the ionospheric reflection. Since the propagation characteristics of the ionospheric channels are extremely complex, the traditional single input and single output skywave communication systems are commonly equipped with relative low system data rates. By configuring a large number of the antennas at the base station side, the massive MIMO technology can serve a large number of the users on the same time-frequency resource, which greatly improves the capacity and the reliability of the system.

The design of a user pecoder in the spatial domain is generally adopted in the existing terrestrial cellular communication system, and the dimension of the user pecoder is equal to the number of the base station antennas. In the massive MIMO system, this dimension is quite large, thus the computation of solving the problem for designing high-dimensional spatial domain precoding is quite considerable. On the other hand, the angle spread of the skywave massive MIMO channel is typically quite little, that is, the beam domain channel is sparse, and the wireless signals sent by the transmitting terminal reach the receiving terminal merely through a limited direction. Therefore, parts of the beam directions can be chose to send the signals, which can implement the almost optimal (traversal) and rate performance.

### SUMMARY

In view of this, the objectives of the present disclosure are to provide a skywave massive MIMO beam structure precoding-based transmission method and a system thereof. This method flexibly selects beam sets by utilizing the beam structure precoder in spatial domain, to design corresponding low dimensional beam domain precoder, which can significantly improve the spectral efficiency of the skywave communication, thereby significantly increasing the transmission rate and the transmission distance, and significantly reducing the complexity of designing the spatial domain precoder.

In order to achieve above objectives, the present disclosure adopts following technical solution.

Provided is a skywave massive MIMO beam structure precoding-based transmission method. The beam structure precoding-based transmission method includes as follows. A skywave massive MIMO communication base station generates a transmitted signal by utilizing a beam structure precoder, and transmits a downlink precoding transmission with one group of users. The beam structure precoder is composed of a low dimensional beam domain precoder of each user, a beam mapping module of each user, and a beam modulating module, the low dimensional beam domain precoder of each user is a precoder on a beam set of each user, the beam mapping module of each user is configured to map a low dimensional beam domain precoding signal of each user to a complete beam domain transmitted signal, the beam modulating module is configured to multiply a beam matrix by a beam domain transmitted signal vector, and the beam domain transmitted signal vector is a sum of beam domain transmitted signal vectors for each user. The base station designs the low dimensional beam domain precoder of each user according to a beam based channel representation of each user and beam domain channel information.

As one improvement of the present disclosure, the beam matrix refers to a matrix composed of array direction vectors corresponding to one selected set of spatial angle sampling grid points, and each of the array direction vectors is called as one beam.

As one improvement of the present disclosure, the beam set of each user refers to a set of beams corresponding to non-zero elements of the beam domain channel in the beam based channel representation of each user, or a selected set including the the beam set of each user.

As one improvement of the present disclosure, the beam based channel representation is expressed by multiplying the beam matrix by a beam domain channel vector, and the beam domain channel information includes an estimated value for the beam domain channel vector and a variance for an estimated error.

As one improvement of the present disclosure, a design of the beam domain precoder includes: a design with an optimization objective of maximizing a system and a rate, a design for maximizing a system traversal and the rate, as well as a design for maximizing the system traversal and a rate upper bound.

(1) In the design with the optimization objective of maximizing the system and the rate, a system and an expression for the rate are updated, by utilizing the beam matrix, a beam mapping matrix of each user, the beam domain precoder of each user and an estimated value for each user, a design problem of a spatial domain precoder is transformed into a design problem of a beam domain precoder, and an iterative design of the beam domain precoder includes following steps.
\textcircled{1} The beam domain precoder of each user is initialized, to satisfy a power constraint.
\textcircled{2} A convex substituting function of the system and the rate under a current iteration are obtained by utilizing a MM algorithm framework.
\textcircled{3} A convex problem of the current iteration is solved by utilizing a Lagrange multiplier means.

Steps \textcircled{2} to \textcircled{3} are repeated until reaching a preset number of iterations or a precoding convergence, and an optimal beam domain precoder ofr each user is obtained.

(2) In the design for maximizing the system traversal and the rate, the system traversal and the rate expression are updated, by utilizing the beam matrix, the beam mapping matrix of each user, the beam domain precoder of each user, the beam domain channel of each user and beam domain statistical channel information of each user, the design problem of the spatial domain precoder is transformed into the design problem of the beam domain precoder, and the iterative design of the beam domain precoder includes following steps.
\textcircled{1} The beam domain precoder of each user is initialized, to satisfy a power constraint.
\textcircled{2} A convex substituting function of the system and the rate under a current iteration are obtained by utilizing a MM algorithm framework.
\textcircled{3} A convex problem of the current iteration is solved by utilizing a Lagrange multiplier means.

Steps \textcircled{2} to \textcircled{3} are repeated until reaching a preset number of iterations or a precoding convergence, and an optimal beam domain precoder of each user is obtained.

(3) In the design for maximizing the system traversal and the rate upper bound, the system traversal and the rate upper bound are obtained, by utilizing a Johnson's inequality of the system traversal and the rate, an expression includes the beam matrix, the beam mapping matrix of each user, the beam domain precoder, the beam domain statistical channel information of each user, the design problem of the spatial domain precoder is transformed into the design problem of the beam domain precoder, and the iterative design of the beam domain precoder includes following steps.
\textcircled{1} The beam domain precoder of each user is initialized, to satisfy a power constraint.
\textcircled{2} A convex substituting function of the system traversal and the rate upper bound under the current iteration are obtained by utilizing an MM algorithm framework.
\textcircled{3} A convex problem of the current iteration is solved by utilizing a Lagrange multiplier means.

Steps \textcircled{2} to \textcircled{3} are repeated until reaching a preset number of iterations or a precoding convergence, and an optimal beam domain precoder of each user is obtained.

As one improvement of the present disclosure, a transmission of the downlink signal with the user implemented by the beam domain precoder generated according to the design includes following steps.

(1) A low dimensional beam domain transmitted signal is generated by multiplying the user beam domain precoder with data symbols transmitted by the beam domain precoder.

(2) A user beam domain transmitted signal is obtained by multiplying the beam mapping matrix with the low dimensional beam domain transmitted signal.

(3) Beam domain transmitted signals of all users are obtained by overlaying the beam domain transmitted signal of each user.

(4) A spatial domain transmitted signal is generated by multiplying the beam domain matrix with the beam domain transmitted signals of all users.

Step (4) is effectively implemented by utilizing a Chirp-z transform.

As one improvement of the present disclosure, the skywave massive MIMO communication base station includes a massive antenna array, an operating carrier frequency with a short wave band ranging from 1.6 MHz to 30 MHz, and the base station transmits signals to the users through an ionospheric reflection.

A skywave massive MIMO beam structure precoding-based transmission system includes a base station and a plurality of users, and the base station implements the skywave massive MIMO beam structure precoding-based transmission method according to any one of claims 1 to 7.

The beneficial effects of the present disclosure are as follows.

The present disclosure can significantly improve the spectral efficiency of the skywave massive MIMO communication in various typical communication scenarios, thereby significantly increasing the transmission rate and the transmission distance. The design of precoder at the base station side merely involves the design of low dimensional beam domain precoder of each user, which can significantly reduce the complexity of the design, whereas the formed beam structure precoding can significantly reduce the implementation complexity of precoding at the base station side. The present disclosure implements optimal design of the low dimensional beam precoder by fully utilizing the beam domain sparsity characteristics of the skywave communication channel, which significantly reduces the complexity of the design of the spatial domain precoder, and possesses the almost optimal (traversal) and rate performance. This solution can flexibly adjust the beam mapping matrix according to the requirements to design and generate user precoder.

### BRIEF DESCRIPTIONS OF THE DRAWINGS

FIG. 1 illustrates a block diagram of a beam structure precoding system.

FIG. 2 illustrates a flowchart of a skywave massive MIMO beam structure precoding-based transmission method provided by Embodiment 1.

FIG. 3 illustrates a comparison diagram of a traversal result and a rate result between the skywave massive MIMO beam structure precoding-based transmission method provided in Embodiment 1 and a MMSE (minimum mean square error)-based precoding transmission method.

### DETAILED DESCRIPTIONS OF THE EMBODIMENTS

In order to clarify the objectives, the technical solutions, and the advantages of the embodiments of the present disclosure to be more clear, the technical solutions in the embodiments of present disclosure will be clearly and completely clarified in conjunction with the accompanying drawings. Obviously, the described embodiments are one part of the embodiments of the present disclosure, not all of them. Based on the embodiments of the present disclosure, all other embodiments obtained by an ordinary person skilled in the art without creative labor are within the protection scope of the present disclosure.

### Embodiment 1

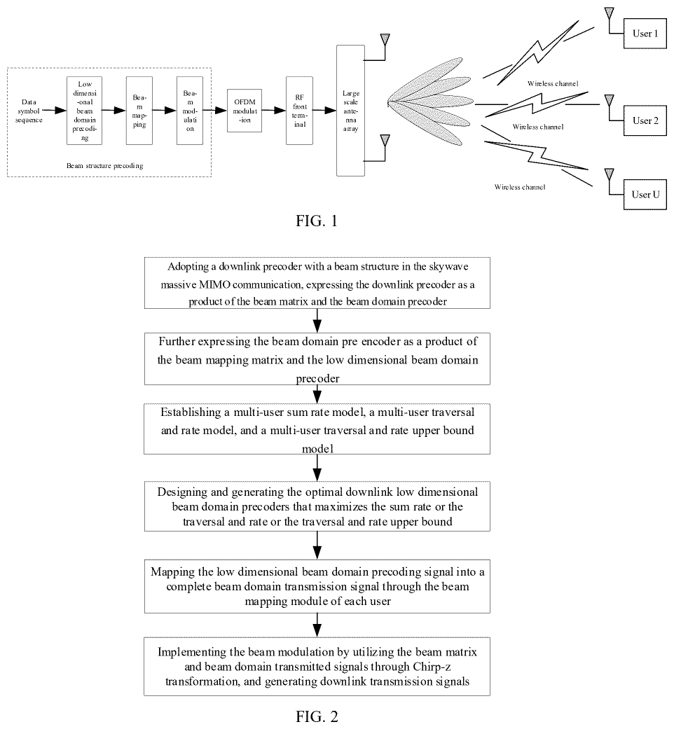

With reference to FIGS. 1 to 3, the embodiment provides a skywave massive MIMO beam structure precoding-based transmission method, and the method is mainly suitable for skywave massive MIMO communication system where the base station is equipped with a large number of antenna arrays to simultaneously serve a large number of single antenna users. The method specifically includes following steps.

A skywave massive MIMO communication base station generates a transmitted signal by utilizing a beam structure precoder, and transmits a downlink precoding transmission with one group of users.

The beam structure precoder is composed of a low dimensional beam domain precoder of each user, a beam mapping module of each user, and a beam modulating module, the low dimensional beam domain precoder of each user is a precoder on a beam set of each user, the beam mapping module of each user is configured to map a low dimensional beam domain precoding signal of each user to a complete beam domain transmitted signal, the beam modulating module is configured to multiply a beam matrix by a beam domain transmitted signal vector, and the beam domain transmitted signal vector is a sum of beam domain transmitted signal vectors for each user.

The base station designs the low dimensional beam domain precoder of each user according to a beam based channel representation of each user and beam domain channel information.

In this embodiment, the specific implementation process of the skywave massive MIMO beam structure precoding-based transmission method are described in details through specific communication system instances. It should be noted that this method is not only apply to the specific system model exemplified in this embodiment, but also to other configured system models.

### 1. System Model

### 1.1 System Setting and Signal Model

By considering a skywave massive MIMO beam communication system, the system is modulated with OFDM and is operated in a time division duplex TDD mode. The base station is equipped with a massive antenna array, the array is a uniform linear antenna array of M antennas with a antenna spacing of d, serving U single antenna users. The system carrier frequency ƒ_{c} is located within the short wave band ranging from 1.6 MHz to 30 MHz. The base station transmits signals to the users through an ionospheric reflection. The skywave massive MIMO-OFDM communication system contains L OFDM symbols in each of the signal frames, the signal frames are divided into \tilde{L} uplink data symbols, one uplink training symbol, and L−\tilde{L}−1 downlink data symbols.

xᵤ(t) [symbol] denotes an analog baseband signal sent to a user u. The analog baseband signal received by the user u is expressed as

$${y}_{u} ( t ) = {\int }_{- ∞}^{∞} {h}_{u}^{H} ( t , τ ) {\sum }_{{u}^{′} = 1}^{U} {x}_{{u}^{′}} ( t - τ ) d τ + {z}_{u} ( t ) \qquad ( 1 )$$

where hᵤ^{H}(t,τ) denotes a downlink channel impulse response of the user u and zᵤ(t) denotes a process of a complex white Gaussian noise.

N_{c}, N_{c} and Tₛ respectively denote the number of subcarriers, a cyclic prefix length, and a system sampling interval. [symbol] ∈ [symbol] is used to denotes a signal on the subcarrier k symbol [symbol] sent to the user u. The signal on the subcarrier k symbol [symbol] demodulated at the user u is expressed as

$${y}_{u , k , ℓ} = {h}_{u , k , ℓ}^{H} {\sum }_{{u}^{′} = 1}^{U} {x}_{{u}^{′} , k , ℓ} + {z}_{u , k , ℓ} \qquad ( 2 )$$

where [symbol] denotes a downlink channel frequency response of the user u, and

$${h}_{u , k , ℓ} = {g}_{u} ( ℓ {T}_{s} ( {N}_{c} + {N}_{g} ) , k Δ f ) \qquad ( 3 )$$

where gᵤ(t,ƒ) denotes a Fourier transform of hᵤ(t,τ), and Δƒ=1/T_{c} denotes a subcarrier spacing, [symbol] denotes a cyclically symmetric complex Gaussian noise with a mean of zero and a variance of [symbol] .

### 1.2 Beam Based Channel Model

Assuming that Pᵤ distinguishable propagation paths exist between the base station and the user u. τ_{u,p} is used to denotes a propagation delay of path p from the base station to the user u. Δτ=d/c is recorded, where c denotes a speed of light. The channel impulse response from the m-th antenna of the base station to the user u is expressed as

$${[ {h}_{u} ( t , τ ) ]}_{m} = {\sum }_{p = 1}^{{P}_{u}} {α}_{u , p} ( t ) {e}^{- j 2 π {f}_{c} ( m - 1 ) Δ {τΩ}_{u , p}} δ ( τ - {τ}_{u , p} - ( m - 1 ) Δ τ {Ω}_{u , p} ) , \qquad ( 4 )$$

where α_{u,p}(t) and Ω_{u,p} denote a complex gain of a path p and a direction cosine of the path p, respectively, and τ_{u,p} denotes a time delay of the path p from the first antenna of the base station to the user u.

Assuming that the path p contains Qₚ subpaths and α_{u,p}(t) can be modeled as

$${α}_{u , p} ( t ) = {\sum }_{q = 1}^{{Q}_{p}} {β}_{u , p , q} {e}^{j {ϕ}_{u , p , q}} {e}^{- j 2 π ( {f}_{c} + {υ}_{u , p , q} ) {τ}_{u , p}} {e}^{j 2 π {υ}_{u , p , q} t} , \qquad ( 5 )$$

where β_{u,p,q}, ϕ_{u,p,q} and ν_{u,p,q} denotes a gain of a subpath q, an initial phase of the subpath q, and a Doppler shift of the subpath q, respectively. Assuming that ϕ_{u,p,q} is uniformly distributed on an interval [0,2π), in a case where Qₚ approaches infinity, α_{u,p}(t) is a stochastic Gaussian stochastic process with zero mean.

According to Formula (3), the channel frequency response of the user u on the subcarrier k symbol [symbol] can be expressed as

$${h}_{u , k , ℓ} = {\sum }_{p = 1}^{{P}_{u}} {α}_{u , p} ( ℓ {T}_{s} ( {N}_{c} + {N}_{g} ) ) {e}^{- j 2 π k Δ f {τ}_{u , p}} v ( {Ω}_{u , p} , k ) , \qquad ( 6 )$$

where α_{u,p}( [symbol] Tₛ(N_{c}+N_{g})) denotes a complex Gaussian random variable with zero mean, and

$$v ( Ω , k ) = {[ 1 , {e}^{- j 2 π ( {f}_{c} + k Δ f ) ΔτΩ} , … , {e}^{- j 2 π ( {f}_{c} + k Δ f ) ( M - 1 ) ΔτΩ} ]}^{T} ∈ {▯}^{M \times 1} , \qquad ( 7 )$$

denotes an array direction vector corresponding to a direction cosine Ω on the subcarrier k, and a superscript T denotes a transpose of a matrix or a vector.

The direction cosine Ω is uniformly sampled. Sₙ∈(2(n−1)/N−1,2n/N−1] is recorded, 1≤n≤N, where N≥M denotes the number of samples. A path direction cosine in the set Sₙ is approximated as ξₙ=(2n−1)/N−1. By recording a set Pᵤ={Ω_{u,l}, . . . , Ω_{u,P}_{ₙ}}, a beam based channel model can be obtained and the model is expressed as

$${h}_{u , k , ℓ} = {\sum }_{n = 1}^{N} {\tilde{h}}_{u , k , ℓ , n} v ( {ξ}_{n} , k ) , \qquad ( 8 )$$

where v(ξₙ,k) denotes a direction cosine of the sampling, which corresponds to a physical spatial beam, and

$${\tilde{h}}_{u , k , ℓ , n} = {\sum }_{{Ω}_{u , p} ∈ {P}_{u} ∩ {S}_{n}} {α}_{u , p} ( ℓ {T}_{s} ( {N}_{c} + {N}_{g} ) ) {e}^{- j 2 π k Δ f {τ}_{u , p}} \qquad ( 9 )$$

is an independent beam domain channel element having complex Gaussian distribution with zero mean. ∩ denotes an intersection of the sets.

[symbol] =\sqrt{M}[ [symbol] , . . . , [symbol] ]^{T} [symbol] denotes the beam domain channel of a scaled user u on the subcarrier k symbol [symbol] , and the beam matrix on the subcarrier k is defined as

$${V}_{k} = \frac{1}{\sqrt{M}} [ v ( {ξ}_{1} , k ) , … , v ( {ξ}_{N} , k ) ] ∈ {▯}^{M \times N} \qquad ( 10 )$$

It can be seen that the beam matrix given by Formula (10) is a matrix composed of the array direction vectors corresponding to one selected set of spatial angle sampling grid points, and each of the array direction vectors is called as a beam. Formula (8) can be rewritten as

$${h}_{u , k , ℓ} = {V}_{k} {\tilde{h}}_{u , k , ℓ} , \qquad ( 11 )$$

and the formula can be considered as a prior channel model before the channel estimation.

The beam domain channel power vector for the user u is defined as

$${ω}_{u , k , ℓ} = E \{ {\tilde{h}}_{u , k , ℓ} ∘ {\tilde{h}}_{u , k , ℓ}^{*} \} ∈ {▯}^{N \times 1} , \qquad ( 12 )$$

$${where [ {ω}_{u , k , ℓ} ]}_{n} = {\sum }_{{Ω}_{u , p} ∈ {P}_{u} ⋂ {S}_{n}} E \{ {\vert {α}_{u , p} ( ℓ {T}_{s} ( {N}_{c} + {N}_{g} ) ) \vert}^{2} \} = {\sum }_{{Ω}_{u , p} ∈ {P}_{u} ⋂ {S}_{n}} {\sum }_{q = 1}^{{Q}_{p}} {β}_{u , p , q}^{2} \qquad ( 13 is$$

independent of symbols and subcarriers, and can be simplified as ωᵤ= [symbol] a superscript * denotes a conjugation of matrices or vectors, E [symbol] denotes a mathematical expectation, ∘ denotes a Hadamard product, and [symbol] denotes a modular operation.

### 1.3. Beam Based Posteriori Channel Model

Vₖĥ_{u,k,\tilde{L}+1}, denotes an estimated channel of the user u on the subcarrier k training symbol \tilde{L}+1, where ĥ_{u,k,\tilde{L}+1} denotes an estimated beam domain channel. Due to the influences of the channel aging, by describing the channel time-varying characteristics through the first order Gaussian Markov process, the beamforming based channel on the subcarrier k symbol [symbol] can be modeled as

$${h}_{u , k , ℓ} = {V}_{k} ( {ϑ}_{u , ℓ} {\hat{h}}_{u , k , \tilde{L} + 1} + \sqrt{1 - {ϑ}_{u , ℓ}^{2}} {\tilde{h}}_{u , k , ℓ} ) , and \qquad ( 14 )$$

the formula can be considered as a posterior channel model and can describe imperfect channel state information in different mobile scenarios. [symbol] denotes a time correlation coefficient between a training symbol \tilde{L}+1 and the symbol [symbol] . Generally, [symbol] is related to channel Doppler spread and can be described by selecting an appropriate channel uncertainty. Specifically, in a case where [symbol] is extremely close to 1, the channel can be considered as quasi-static, and in a case where [symbol] is close to 0, the channel changes dramatically. The beam based channel presented in Formula (14) is expressed by multiplying the beam matrix by the beam domain channel vector. The beam domain channel information includes the estimated value for the beam domain channel vector and the variance for the estimation error.

The beam domain channel in skywave massive MIMO communication is generally sparse in space, which indicates that most elements of the beam domain channel are close to zero. The set of beams corresponding to non-zero elements in the beam domain channel is expressed as Nᵤ={n [symbol] ≠0} and Ñ=|N|. One set N=N₁∪ . . . ∪Nᵤ is defined and N̅=|N|, where ∪ denotes an union of the sets. V̅ₖ=[Vₖ]_{:,N} [symbol] is used to denote a reduced dimensional beam matrix. Formula (14) can be rewritten as

$${h}_{u , k , ℓ} = {\overline{V}}_{k} {\overline{h}}_{u , k , ℓ} , \qquad ( 15 )$$

$$where {\overline{h}}_{u , k , ℓ} = {{θ}_{u , ℓ} [ {\hat{h}}_{u , k , \tilde{L} + 1} ]}_{N} + {\sqrt{1 - {ϑ}_{u , ℓ}^{2}} [ {\tilde{h}}_{u , k , ℓ} ]}_{N} , \qquad ( 16 )$$

and a complete expression of the channel frequency response can be obtained by N̅ beam.

### 2. Robust Precoding

### 2.1 Problem Formationon

The downlink transmission on the subcarrier k symbol [symbol] is considered. For concise expression, symbol subscripts k and [symbol] are omitted in the followings. By considering the linear precoding, the signal model presented in Formula (2) can be rewritten as

$${y}_{u} = {h}_{u}^{H} {\sum }_{{u}^{′} = 1}^{U} {p}_{{u}^{′}} {s}_{{u}^{′}} + {z}_{u} , \qquad ( 17 )$$

where pᵤ denotes the precoder of the user u, sᵤ denotes a data symbol sent to the user u and the symbol with a zero mean and an unit variance.

The interference plus noise

$${h}_{u}^{H} {\sum }_{{u}^{′} \neq u}^{U} {p}_{{u}^{′}} {s}_{{u}^{′}} + {z}_{u}$$

at the position where the user u is located are taken as Gaussian noise, a covariance of whom is expressed as

$${\sum }_{{u}^{′} \neq u}^{U} {p}_{{u}^{′}}^{H} E \{ {h}_{u} {h}_{u}^{H} \} {p}_{{u}^{′}} + {σ}_{u}^{2} .$$

In a case where the user u can obtain the variance, the traversal rate of the variance can be expressed as

$${r}_{u} = E \{ log ( 1 + \frac{{p}_{u}^{H} {h}_{u} {h}_{u}^{H} {p}_{u}}{{σ}_{u}^{2} + {\sum }_{{u}^{′} \neq u}^{U} {p}_{{u}^{′}}^{H} E \{ {h}_{u} {h}_{u}^{H} \} {p}_{{u}^{′}}} ) \} . \qquad ( 18 )$$

The problem of designing the robust precoding of maximizing a traversal and rate can be expressed as

$$\begin{matrix}{p}_{1}^{o p} , … , {p}_{U}^{o p} = {arg max}_{{p}_{1} , … , {p}_{U}} {\sum }_{u = 1}^{U} {r}_{u} \\ s . t . {\sum }_{u = 1}^{U} {p}_{u}^{H} {p}_{u} \leq P\end{matrix} , \qquad ( 19 )$$

where P denotes a total transmission power constraint. Due to the large number of base station antennas in the massive MIMO communication, the optimizing problem mentioned above is high-dimensional, and solving and obtaining the optimal solution requires a complex computation.

### 2.2. Robust Precoding of Beam Structure

The vector qᵤ=V̅^{H}pᵤ [symbol] , u=1, . . . , U is defined. The traversal rate r can be rewritten as

$${r}_{u} = E \{ log ( 1 + \frac{{q}_{u}^{H} {\overline{h}}_{u} {\overline{h}}_{u}^{H} {q}_{u}}{{σ}_{u}^{2} + {\sum }_{{u}^{′} \neq u}^{U} {q}_{{u}^{′}}^{H} E \{ {\overline{h}}_{u} {\overline{h}}_{u}^{H} \} {q}_{{u}^{′}}} ) \} , \qquad ( 20 )$$

where the formula includes beam domain channel h̅₁, . . . , h̅_{U} instead of spatial domain channel h₁, . . . , h_{U}. Therefore, q₁, . . . , q_{U} can be considered as a precoder in the beam domain channel. On the other hand, q₁, . . . , q_{U} can be obtained by the spatial domain precoders p₁, . . . , p_{U} through the conversion of the beam matrix V̅. Therefore, q₁, . . . , q_{U} is called as a beam domain precoder.

A=V̅^{H}(V̅^{H})^{†}−I and G=(V̅^{H}V̅)^{†} are simplifiedly recorded, where the superscript † denotes a pseudo inverse operator. Then, by considering the optimization of vectors, q₁, . . . , q_{U} the traversal and rate are maximized. It can be proven that for an arbitrary vector a [symbol] , the sufficient and necessary condition for holding a=V̅^{H}b and b [symbol] to be true is that

$$Aa = 0. \qquad ( 21 )$$

In view of this, it can be concluded that in a case where qᵤ satisfies Aqᵤ=0, the spatial domain precoder pᵤ is permanently available according to the relation formula qᵤ=V̅^{H}pᵤ. The optimal solution for the optimization problem (19) can be obtained as

$${p}_{u}^{o p} = \overline{V} G {q}_{u}^{o p} , for u = 1 , … , U , \qquad ( 22 )$$

$$where {q}_{1}^{o p} , … , {q}_{U}^{o p} = {arg max}_{{q}_{1} , … , {q}_{U}} {\sum }_{u = 1}^{U} E \{ log ( 1 + \frac{{q}_{u}^{H} {\overline{h}}_{u} {\overline{h}}_{u}^{H} {q}_{u}}{{σ}_{u}^{2} + {\sum }_{{u}^{′} \neq u}^{U} {q}_{{u}^{′}}^{H} E \{ {\overline{h}}_{u} {\overline{h}}_{u}^{H} \} {q}_{{u}^{′}}} ) \} , and \qquad ( 23 )$$

$$s . t . {\sum }_{u = 1}^{U} {q}_{u}^{H} G {q}_{u} \leq P , A {q}_{u} = 0 , for u = 1 , … , U .$$

Formula (22) provides the optimal spatial domain precoding structure. After the optimization problem (23) is solved and the optimal solution is obtained, the optimal spatial domain precoder is given in Formula (22). However, the dimension of Problem (23) may still be quite large, and the solution process of Problem (23) is computationally complex. Further assuming that the number of users is finite, and the direction cosine of the users is discrete and limit. In a case where M approaches infinity, having

$${lim}_{M \to ∞} {\overline{V}}^{H} \overline{V} = I ,$$

and further having

$${lim}_{M \to ∞} A = 0 and {lim}_{M \to ∞} G = I .$$

At this situation, the optimal solution (22) is changed into

$${p}_{u}^{o p} = \overline{V} {\overline{q}}_{u}^{o p} , in a case where u = 1 , … , U \qquad ( 24 )$$

$$\begin{matrix}{\overline{q}}_{1}^{o p} , … , {\overline{q}}_{U}^{o p} = {arg max}_{{q}_{1} , … , {q}_{U}} {\sum }_{u = 1}^{U} E \{ log ( 1 + \frac{{q}_{u}^{H} {\overline{h}}_{u} {\overline{h}}_{u}^{H} {q}_{u}}{{σ}_{u}^{2} + {\sum }_{{u}^{′} \neq u}^{U} {q}_{{u}^{′}}^{H} E \{ {\overline{h}}_{u} {\overline{h}}_{u}^{H} \} {q}_{{u}^{′}}} ) \} \\ s . t . {\sum }_{u = 1}^{U} {q}_{u}^{H} {q}_{u} \leq P .\end{matrix} \qquad ( 25 )$$

After the optimal solution for the beam domain optimization problem (25) is obtained, the asymptotic optimal spatial domain precoder is expressed as Formula (24). Specifically, it is observed that the spatial domain precoder structure of Formula (22) is changed into a simple beam structure precoder as expressed in Formula (24). In other words, in a case where the base station is equipped with the sufficient number of antennas, the design of the beam structure precoder is asymptotically optimal. Further the optimal solution obtained for Problem (25) satisfies

$${[ {\overline{q}}_{u}^{o p} ]}_{n} = 0 , {[ N ]}_{n} ∉ {N}_{u} . \qquad ( 26 )$$

The above formula indicates that in a case where M is sufficiently large, all elements outside the non-zero beam set of the beam domain precoder qᵤ are 0. On the basic of this conclusion, it is possible to focus merely on non-zero elements of q₁, . . . , q_{U} whose dimensions are quite small.

A Matrix Φᵤ [symbol] , is defined as

$${[ {Φ}_{u} ]}_{i , j} = \{ \begin{matrix}1 , i = {[ {N}_{u} ]}_{j} for j = 1 , … , {N}_{u} \\ 0 , else\end{matrix} \qquad ( 27 )$$

At this situation, the beam structure precoder (24) is changed into

$${p}_{u} = V {Φ}_{u} {w}_{u} , \qquad ( 28 )$$

where wᵤ denotes the low dimensional beam domain precoder corresponding to the non-zero elements of qᵤ,Φᵤ denotes the non-zero beams used by the beam mapping matrix to map the user u.

According to Formula (28), the transmitted signal vector x can be rewritten as

$$x = V {\sum }_{u = 1}^{U} {Φ}_{u} {w}_{u} {s}_{u} . \qquad ( 29 )$$

According to Formula (29), the beam domain precoder generated by the design is utilized to implement downlink signal transmission with the user, which includes the following steps.

In Step 1, wᵤsᵤ denotes that a low dimensional beam domain transmitted signal is generated by multiplying the beam domain precoder of the user u with data symbols transmitted by the beam domain precoder.

In Step 2, Φᵤwᵤsᵤ denotes that a user u beam domain transmitted signal is obtained by multiplying the beam mapping matrix Φᵤ with the low dimensional beam domain transmitted signal.

In Step 3, a beam domain transmitted signal

$${\sum }_{u = 1}^{U} {Φ}_{u} {w}_{u} {s}_{u}$$

including all users is obtained by overlaying the beam domain transmitted signal of each user.

In Step 4, a spatial domain transmitted signal x is generated by multiplying the beam domain matrix V with the beam domain transmitted signal

$${\sum }_{u = 1}^{U} {Φ}_{u} {w}_{u} {s}_{u}$$

including all users, that is, the process of beam modulation.

Specifically, Step 4 can be effectively implemented by utilizing the Chirp-z transform.

$${B}_{u , {u}^{′}} = {Φ}_{u}^{T} {V}^{H} V {Φ}_{{u}^{′}} and {{h}^{⌣}}_{u} = {[ {\hat{h}}_{u} ]}_{{N}_{u}} + {\sqrt{1 -} [ {\tilde{h}}_{u} ]}_{{N}_{u}} ∈ {▯}^{{N}_{u} \times 1} \qquad ( 30 )$$

are simplifiedly recorded.

At this situation, hᵤ=VΦᵤȟᵤ, and Ω̌ᵤ is defined as

$${{Ω}^{⌣}}_{u} = E \{ {{h}^{⌣}}_{u} {{h}^{⌣}}_{u}^{H} \} = {{[ {\hat{h}}_{u} ]}_{{N}_{u}} [ {\hat{h}}_{u}^{H} ]}_{{N}_{u}} + ( 1 - ) diag ( {[ {ω}_{u} ]}_{{N}_{u}} ) . \qquad ( 31 )$$

The expression of the traversal rate for the user u given in Formula (18) is changed into

$${r}_{u} = E \{ log ( 1 + \frac{{w}_{u}^{H} {B}_{u , u} {{h}^{⌣}}_{u} {{h}^{⌣}}_{u}^{H} {B}_{u , u} {w}_{u}}{{σ}_{u}^{2} + {\sum }_{{u}^{′} \neq u}^{U} {w}_{{u}^{′}}^{H} {B}_{{u}^{′} , u} {{Ω}^{⌣}}_{u} {B}_{u , {u}^{′}} {w}_{{u}^{′}}} ) \} , \qquad ( 32 )$$

where the traversal rate expression (32) includes the beam matrix, user beam mapping matrix, user beam domain precoder, and user channel estimated value.

Next, by considering the optimization of the beam domain precoder w₁, . . . , w_{U}. the traversal and rate are maximized, and the problem is expressed as

$$\begin{matrix}{w}_{1}^{op} , … , {w}_{u}^{op} = {arg max}_{{w}_{1} , … , {w}_{U}} {\sum }_{u = 1}^{U} {r}_{u} \\ s . t . {\sum }_{u = 1}^{U} {w}_{u}^{H} {B}_{u , u} {w}_{u} \leq P\end{matrix} . \qquad ( 33 )$$

In view of this, the design problem of spatial domain precoder (19) is transformed into a design problem of beam domain precoder (33). In comparison with Formula (19) of the spatial domain precoder design problem, the dimension of the beam domain precoder design problem (33) is extremely little. Specifically, in a case where M is sufficient large and the non-zero beam of the user is changed into orthogonal, Problems (33) and (25) are the same.

### 2.3 Beam Modulation Based on Chirp-z Transform

The beam modulation given in Formula (29) can be rewritten as

$$x = Vs , \qquad ( 34 )$$

$$s = {\sum }_{u = 1}^{U} {Φ}_{u} {w}_{u} {s}_{u} \qquad ( 35 )$$

where in Formula (34), it is noted that the beam matrix V can be considered as a CZT matrix, which is expressed as the product of three matric, that is, a diagonal matrix Γ [symbol] Γ [symbol] , a Toplitz matrix T [symbol] , and another diagonal matrix Λ [symbol] , and expressed as

$$V = Γ T Λ \qquad ( 36 )$$

$$Γ = \frac{1}{\sqrt{M}} diag ( 1 , {W}^{( 2 - N ) / 2} , {W}^{( M - 1 ) ( N - N ) / 2} ) \qquad ( 37 )$$

$$T = [ \begin{matrix}{W}^{- \frac{{( 0 - 0 )}^{2}}{2}} & … & {W}^{- \frac{{( 0 - ( N - 1 ) )}^{2}}{2}} \\ ⋮ & ⋱ & ⋮ \\ {W}^{- \frac{{( ( M - 1 ) - 0 )}^{2}}{2}} & … & {W}^{- \frac{{( ( M - 1 ) - ( N - 1 ) )}^{2}}{2}}\end{matrix} ] \qquad ( 38 )$$

$$Λ = diag ( 1 , {W}^{1 / 2} , … , {W}^{{( N - 1 )}^{2} / 2} ) , \qquad ( 39 )$$

where W=e^{-j4π(ƒ}^{_{c}}^{+kΔƒ)Δt/N}.

Further, Toplitz matrix T is expressed as

$$T = {F}_{S \times M}^{H} Π {F}_{S \times N} , \qquad ( 40 )$$

where S≥M+N−1, Π denotes a diagonal matrix, F_{S×M} denotes a matrix that contains the the front M columns of a S point DFT matrix. By substituting Formulas (40) and (36) into Formula (34), it can be obtained that

$$x = Γ {F}_{S \times M}^{H} Π {F}_{S \times N} Λ s , \qquad ( 41 )$$

which can be effectively implemented through fast fourier transform (FFT) and inverse FFT.

### 3. Design of Robust Beam Domain Precoder

### 3.1. Design of Beam Domain Precoder Based on MM Algorithm Framework

The design problem (33) of beam domain precoder is non convex, whose global optimal solution is difficult to be obtained. Based on the MM algorithm framework, an iterative local optimal solution is derived. In the d-th iteration, wᵤ^{(d)} is used to express wᵤ, a function ƒ(w₁, . . . , w_{U}|w₁^{(d)}, . . . , w_{U}^{(d)}) is defined to minimize ƒ(w₁, . . . , w_{U}|w₁^{(d)}, . . . , w_{U}^{(d)}) in a case where

$$f ( {w}_{1} , … , {w}_{U} \vert {w}_{1}^{( d )} , … , {w}_{U}^{( d )} ) \leq {\sum }_{u = 1}^{U} {r}_{u} ( {w}_{1} , … , {w}_{U} ) \qquad ( 42 )$$

$$f ( {w}_{1}^{( d )} , … , {w}_{U}^{( d )} \vert {w}_{1}^{( d )} , … , {w}_{U}^{( d )} ) \leq {\sum }_{u = 1}^{U} {r}_{u} ( {w}_{1}^{( d )} , … , {w}_{U}^{( d )} ) \qquad ( 43 )$$

Further, Formulas (42) and (43) indicate that

$${{\frac{\partial f}{\partial {w}_{u}} \vert}_{{w}_{u} = {w}_{u}^{( d )}} = {\sum }_{u = 1}^{U} \frac{\partial {r}_{u}}{\partial {w}_{u}} \vert}_{{w}_{u} = {w}_{u}^{( d )}} , in a case where u = 1 , … , U . \qquad ( 44 )$$

Next, an alternative function ƒ is searched to minimize

$${\sum }_{u = 1}^{U} {r}_{u}$$

at an arbitrary point on the function, and then maximize ƒ to obtain the iterative solution of the original problem. Specifically, w₁^{(d+1)}, . . . , w_{U}^{(d+1)} what is recorded as the solution for maximizing ƒ, according to formulas (42) and (43), it can be obtained that

$${\sum }_{u = 1}^{U} {r}_{u} ( {w}_{1}^{( d + 1 )} , … , {w}_{U}^{( d + 1 )} ) \geq {\sum }_{u = 1}^{U} {r}_{u} ( {w}_{1}^{( d )} , … , {w}_{U}^{( d )} ) \qquad ( 45 )$$

Conditions (44) and (45) can ensure that the generated sequence can converge to a local optimal solution.

ρᵤ is simplifiedly recorded as

$${ρ}_{u} = {σ}_{u}^{2} + {\sum }_{{u}^{′} \neq u}^{U} {w}_{{u}^{′}}^{H} {B}_{{u}^{′} , u} {{Ω}^{⌣}}_{u} {B}_{u , {u}^{′}} {w}_{{u}^{′}} . \qquad ( 46 )$$

One following alternative function for

$${\sum }_{u = 1}^{U} {r}_{u}$$

can be obtained, and which is expressed as

$$f = {\sum }_{u = 1}^{U} {a}_{u}^{( d )} + {\sum }_{u = 1}^{U} {( {C}_{u}^{( d )} {w}_{u}^{( d )} )}^{H} {w}_{u} + {\sum }_{u = 1}^{U} {w}_{u}^{H} {C}_{u}^{( d )} {w}_{u}^{( d )} - {\sum }_{u = 1}^{U} {w}_{u}^{H} {F}_{u}^{( d )} {w}_{u} , \qquad ( 47 )$$

where αᵤ^{(d)} denotes a constant and

$${C}_{u}^{( d )} = {( {ρ}_{u}^{( d )} )}^{- 1} {B}_{u , u} E \{ {\breve{h}}_{u} {\breve{h}}_{u}^{H} \} {B}_{u , u} \qquad ( 48 )$$

$${D}_{u}^{( d )} = {B}_{u , u} E \{ ( {( {ρ}_{u}^{( d )} )}^{- 1} - {( {ρ}_{u}^{( d )} + {( {w}_{u}^{( d )} )}^{H} {B}_{u , u} {\breve{h}}_{u} {\breve{h}}_{u}^{H} {B}_{u , u} {w}_{u}^{( d )} )}^{- 1} ) {\breve{h}}_{u} {\breve{h}}_{u}^{H} \} {B}_{u , u} \qquad ( 49 )$$

$${E}_{u , {u}^{′}}^{( d )} = ( {( {ρ}_{u}^{( d )} )}^{- 1} - E \{ {( {ρ}_{u}^{( d )} + {( {w}_{u}^{( d )} )}^{H} {B}_{u , u} {\breve{h}}_{u} {\breve{h}}_{u}^{H} {B}_{u , u} {w}_{u}^{( d )} )}^{- 1} \} ) {B}_{{u}^{′} , u} E \{ {\breve{h}}_{u} {\breve{h}}_{u}^{H} \} {B}_{u , {u}^{′}} \qquad ( 50 )$$

$${F}_{u}^{( d )} = {D}_{u}^{( d )} + {\sum }_{{u}^{′} \neq u}^{U} {E}_{{u}^{′} , u}^{( d )} . \qquad ( 51 )$$

Based on the alternative function ƒ, the optimal solution for the (d+1)-th iteration can be obtained by solving the following optimization problem:

$${w}_{1}^{( d + 1 )} , … , {w}_{U}^{( d + 1 )} = {max}_{{w}_{1} , … , {w}_{U}} {\sum }_{u = 1}^{U} ( {( {C}_{u}^{( d )} {w}_{u}^{( d )} )}^{H} {w}_{u} + {w}_{u}^{H} {C}_{u}^{( d )} {w}_{u}^{( d )} - {w}_{u}^{H} {F}_{u}^{( d )} {w}_{u} ) s . t . {\sum }_{u = 1}^{U} {w}_{u}^{H} {B}_{u , u} {w}_{u} \leq P . \qquad ( 52 )$$

This problem is a concave quadratic optimization problem, and the optimal solution of the problem can be solved using the Lagrange multiplier method.

The Lagrange function of optimization problem (52) can be expressed as

$$L = {\sum }_{u = 1}^{U} ( {( {C}_{u}^{( d )} {w}_{u}^{( d )} )}^{H} {w}_{u} + {w}_{u}^{H} {C}_{u}^{( d )} {w}_{u}^{( d )} - {w}_{u}^{H} {F}_{u}^{( d )} {w}_{u} ) - μ ( {\sum }_{u = 1}^{U} {w}_{u}^{H} {B}_{u , u} {w}_{u} - P ) , \qquad ( 53 )$$

where μ≥0 denotes Lagrange multipliers. According to the first-order optimal condition, the optimal solution to Problem (52) is expressed as

$${w}_{u}^{( d + 1 )} = {( {F}_{u}^{( d )} + {μ}^{op} {B}_{u , u} )}^{- 1} {C}_{u}^{( d )} {w}_{u}^{( d )} , \qquad ( 54 )$$

where μ^{op} denotes the optimal Lagrange multiplier. It is noted that is

$${\sum }_{u = 1}^{U} {( {w}_{u}^{( d + 1 )} )}^{H} {B}_{u , u} {w}_{u}^{( d + 1 )}$$

a monotonically decreasing function of μ. Therefore, in a case where μ^{op}=0 and

$${\sum }_{u = 1}^{U} {( {w}_{u}^{( d + 1 )} )}^{H} {B}_{u , u} {w}_{u}^{( d + 1 )} \leq P ,$$

the optimal solution is changed into wᵤ^{(d+1)}=(Fᵤ^{(d)})⁻¹Cᵤ^{(d)}wᵤ^{(d)}. Otherwise, the binary method can be used to solve the optimal μ^{op}. The specific process of beam domain robust precoding design is given in the followings.

In Step 1, the beam domain precoders w₁⁽⁰⁾, . . . , w_{U}⁽⁰⁾ for each user are initialized to satisfy the power constraint

$${\sum }_{u = 1}^{U} {( {w}_{u}^{( 0 )} )}^{H} {B}_{u , u} {w}_{u}^{( 0 )} \leq P .$$

d=0 is set.

In Step 2, MM algorithm framework is used to obtain the convex alternative functions for the system traversal and the rate in the current iteration, that is, according to Formulas (48), (49), (50), and (51), Cᵤ^{(d)}, Dᵤ^{(d)}, E_{u,u′}^{(d)} and Fᵤ^{(d)} are calculated, respectively.

In Step 3, the Lagrange multiplier method is used to solve the convex problem of the current iteration, that is, wᵤ^{(d+1)} is updated and d=d+1 is set according to Formula (54). Steps 2 and 3 are repeated until the preset number of iterations or precoding convergence is reached.

The optimal beam domain precoder w^{op}=wᵤ^{(d)} for each user is obtained, in a case where u=1, . . . , U.

### 3.2. Design of Low Complexity Beam Domain Precoder

In general, since the traversal rate given by Formula (32) does not have a closed form expression, a complex Monte Carlo averaging is currently required to calculate the corresponding expected values. Further, the design of low complexity beam domain robust precoder based on traversal and rate upper bound is studied. The system upper bound is obtained by the traversal rate through the Johnson inequality, and the expression is expressed as

$${r}_{u} = log ( 1 + \frac{{w}_{u}^{H} {B}_{u , u} E \{ {\breve{h}}_{u} {\breve{h}}_{u}^{H} \} {B}_{u , u} {w}_{u}}{{σ}_{u}^{2} + {\sum }_{{u}^{′} \neq u}^{U} {w}_{{u}^{′}}^{H} {B}_{{u}^{′} , u} {\breve{Ω}}_{u} {B}_{u , {u}^{′}} {w}_{{u}^{′}}} ) = log ( 1 + \frac{{w}_{u}^{H} {B}_{u , u} {\breve{Ω}}_{u} {B}_{u , u} {w}_{u}}{{σ}_{u}^{2} + {\sum }_{{u}^{′} \neq u}^{U} {w}_{{u}^{′}}^{H} {B}_{{u}^{′} , u} {\breve{Ω}}_{u} {B}_{u , {u}^{′}} {w}_{{u}^{′}}} ) = {r}_{u}^{u b} , \qquad ( 55 )$$

where the rate upper bound is extremely tight for single antenna users and the expression includes the beam matrix, the user beam mapping matrix, the beam domain precoder, and user beam domain statistical channel information.

By considering a novel design problem for beam domain precoder, the traversal and rate upper bound are maximized, and the problem is expressed as

$${w}_{1}^{op} , … , {w}_{U}^{op} = {arg max}_{{w}_{1} , … , {w}_{U}} {\sum }_{u = 1}^{U} {r}_{u}^{u b} s . t . {\sum }_{u = 1}^{U} {w}_{u}^{H} {B}_{u , u} {w}_{u} \leq P , \qquad ( 56 )$$

where the objective function of the problem does not include the expected operations. However, Problem (56) is still non convex, whose global optimal solution is difficult to be obtained.

It is observed that the differences between Problems (56) and (33) are in the objective function. Λ̌ᵤ exists in (56) instead of Λ̌ᵤ in (33) and no expected operations are contained. Based on the MM algorithm framework, the iterative local optimal solution of problem (56) can be derived similarly. At the (d+1)-th iteration, the optimal solution can be expressed as

$${w}_{u}^{( d + 1 )} = {( {\tilde{D}}_{u}^{( d )} + {\sum }_{{u}^{′} \neq u}^{U} {\tilde{E}}_{{u}^{′} , u}^{( d )} + {μ}^{op} {B}_{u , u} )}^{- 1} {\tilde{C}}_{u}^{( d )} {w}_{u}^{( d )} \qquad ( 57 )$$

where μ^{op} denotes the optimal Lagrange multiplier.

$${\tilde{C}}_{u}^{( d )} = {( {ρ}_{u}^{( d )} )}^{- 1} {B}_{u , u} {\breve{Ω}}_{u} {B}_{u , u} \qquad ( 58 )$$

$${\tilde{D}}_{u}^{( d )} = ( {( {ρ}_{u}^{( d )} )}^{- 1} - {( {ρ}_{u}^{( d )} + {( {w}_{u}^{( d )} )}^{H} {B}_{u , u} {\breve{Ω}}_{u} {B}_{u , u} {w}_{u}^{( d )} )}^{- 1} ) {B}_{u , u} {\breve{Ω}}_{u} {B}_{u , u} \qquad ( 59 )$$

$${\tilde{E}}_{u , {u}^{′}}^{( d )} = ( {( {ρ}_{u}^{( d )} )}^{- 1} - {( {ρ}_{u}^{( d )} + {( {w}_{u}^{( d )} )}^{H} {B}_{u , u} {\breve{Ω}}_{u} {B}_{u , u} {w}_{u}^{( d )} )}^{- 1} ) {B}_{{u}^{′} , u} {\breve{Ω}}_{u} {B}_{u , {u}^{′}} \qquad ( 60 )$$

By substituting Cᵤ^{(d)} and Dᵤ^{(d)} as well as ȟᵤȟᵤ^{H} in E_{u,u′}^{(d)} in Theorem 3 for Ω̌ᵤ, and by omitting the corresponding expected operation, \tilde{D}ᵤ^{(d)}=\tilde{E}_{u,u}^{(d)} is noted, and the expression is further obtained and expressed as

$${w}_{u}^{( d + 1 )} = {( {\sum }_{{u}^{′} = 1}^{U} {\tilde{E}}_{{u}^{′} , u}^{( d )} + {μ}^{op} {B}_{u , u} )}^{- 1} {\tilde{C}}_{u}^{( d )} {w}_{u}^{( d )} . \qquad ( 61 )$$

Given in the following is the design process of a low complexity beam domain robust precoder.

In Step 1, the beam domain precoder w₁⁽⁰⁾, . . . , w_{U}⁽⁰⁾ for each user is initialized, to satisfy a power constraint

$${\sum }_{u = 1}^{U} ( {w}_{u}^{( 0 )} ) {B}_{u , u} {w}_{u}^{( 0 )} \leq P ,$$

and d=0 is set.

In Step 2, a convex substituting function of the system traversal and the rate upper bound under a current iteration are obtained by utilizing a MM algorithm framework, that is, Čᵤ^{(d)} and Ě_{u,u′}^{(d)} are calculated respectively according to Formulas (58) and (60).

In Step 3, a convex problem of the current iteration is solved by utilizing a Lagrange multiplier means, that is, wᵤ^{(d+1)} is updated and wᵤ^{(d+1)} is set according to Formula (61). Steps \textcircled{2} to \textcircled{3} are repeated until reaching the convergence.

The optimal beam domain precoder wᵤ^{op}=wᵤ^{(d)} for each user is obtained, in a case where u=1, . . . , U.

In order to verify the progressiveness and superiority of a skywave massive MIMO beam structure precoding based transmission method by using imperfect channel state information provided by this embodiment, simulation comparison tests are conducted on this method and MMSE precoding downlink transmission method based on instantaneous channel state information in this embodiment.

Specifically, by considering the skywave massive MIMO-OFDM communication system with skywaves, the system parameter configuration is set as follows. The carrier frequency is f_{c}=25 MHz, an antenna array spacing between skywave communication base stations d=5.8 m the system bandwidth is B=192 KHz, the system sampling interval is Tₛ=3.9 μs, the subcarrier interval is Δf=125 Hz, the number of subcarriers is N_{c}=2048, and CP points is N_{g}=512 For the setting for the skywave massive MIMO communication base station, the number of antennas is M=256, sampling beams is N=512, and the number of users is U=64. The total transmission power is defined as the sum of the transmission power of 64 users on the system bandwidth, and the traversal sum rate is the average of the traversal sum rates on all effective subcarriers.

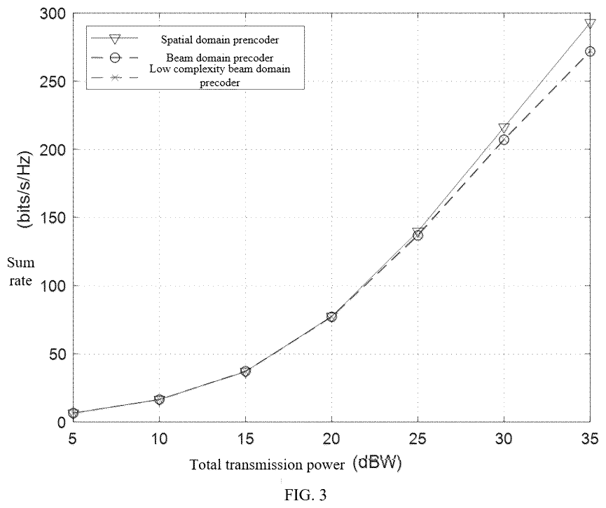

FIG. 3 illustrates the comparison of the traversal and rate results of the spatial domain precoder design for maximizing traversal and rate, the beam domain precoder design for maximizing traversal and rate, and the beam domain precoder design for maximizing traversal and rate upper bound (low complexity beam domain precoder) under different total transmission powers by utilizing the method in this embodiment. It can be seen from FIG. 3 that the system traversal and rate results increase with the increase of total transmission power. In comparison with the spatial domain precoding transmission method, the skywave massive MIMO beam structure precoding-based transmission method in this embodiment can implement almost optimal system traversal and rate performance with relatively low complexity.

The aspects of the present disclosure that are not described in detail are common sense to those person skilled in the art.

The above provides a detailed description of the preferred embodiments of the present disclosure. It should be understood that ordinary person skilled in the art can make many modifications and changes based on the concept of the present disclosure without creative labor. Therefore, any technical solution that can be obtained by a person skilled in the art based on the concept of the present disclosure through logical analysis, reasoning, or limited experiments on the basis of existing technology should be within the protection scope defined by the claims.

1. A skywave massive MIMO beam structure precoding-based transmission method, wherein the method comprises following steps:
generating, by utilizing a beam structure precoder, a transmitted signal, through a skywave massive MIMO communication base station, and transmitting a downlink precoding with one group of users; wherein
the beam structure precoder is composed of a low dimensional beam domain precoder of each user, a beam mapping module of each user, and a beam modulating module, the low dimensional beam domain precoder of each user is a precoder on a beam set of each user, the beam mapping module of each user is configured to map a low dimensional beam domain precoding signal of each user to a complete beam domain transmitted signal, the beam modulating module is configured to multiply a beam matrix by a beam domain transmitted signal vector, and the beam domain transmitted signal vector is a sum of beam domain transmitted signal vectors for each user;
designing, by the base station, the low dimensional beam domain precoder of each user, according to a beam based channel representation of each user and beam domain channel information.

2. The skywave massive MIMO beam structure precoding-based transmission method according to claim 1, wherein the beam matrix refers to a matrix composed of array direction vectors corresponding to one selected set of spatial angle sampling grid points, and each of the array direction vectors is called as one beam.

3. The skywave massive MIMO beam structure precoding-based transmission method according to claim 1, wherein the beam set of each user refers to a set of beams corresponding to non-zero elements of the beam domain channel in the beam based channel representation of each user, or a selected set including the beam set of each user.

4. The skywave massive MIMO beam structure precoding-based transmission method according to claim 3, wherein the beam based channel representation is expressed by multiplying the beam matrix by a beam domain channel vector, and the beam domain channel information includes an estimated value for the beam domain channel vector and a variance for an estimated error.

5. The skywave massive MIMO beam structure precoding-based transmission method according to claim 1, wherein a design of the beam domain precoder includes: a design with an optimization objective of maximizing a system and a rate, a design for maximizing a system traversal and the rate, as well as a design for maximizing the system traversal and a rate upper bound.

6. The skywave massive MIMO beam structure precoding-based transmission method according to claim 1, wherein
(1) in the design with the optimization objective of maximizing the system and the rate, a system and an expression for the rate are updated, by utilizing the beam matrix, a beam mapping matrix of each user, the beam domain precoder of each user and an estimated value for each user, a design problem of a spatial domain precoder is transformed into a design problem of a beam domain precoder, and an iterative design of the beam domain precoder includes following steps:
\textcircled{1} initializing the beam domain precoder of each user, to satisfy a power constraint;
\textcircled{2} obtaining, by utilizing an MM algorithm framework, a convex substituting function of the system and the rate under a current iteration;
\textcircled{3}, solving, by utilizing a Lagrange multiplier means, a convex problem of the current iteration; and
repeating, until reaching a preset number of iterations or a precoding convergence, Steps \textcircled{2} to \textcircled{3}, and obtaining an optimal beam domain precoder of each user;
(2) in the design for maximizing the system traversal and the rate, the system traversal and the rate expression are updated, by utilizing the beam matrix, the beam mapping matrix of each user, the beam domain precoder of each user, the beam domain channel of each user and beam domain statistical channel information of each user, the design problem of the spatial domain precoder is transformed into the design problem of the beam domain precoder, and the iterative design of the beam domain precoder includes following steps:
\textcircled{1} initializing the beam domain precoder of each user, to satisfy the power constraint;
\textcircled{2} obtaining, by utilizing an MM algorithm framework, a convex substituting function of the system traversal and the rate under a current iteration;
\textcircled{3} solving, by utilizing a Lagrange multiplier means, a convex problem of the current iteration; and
repeating, until reaching a preset number of iterations or a precoding convergence, Steps \textcircled{2} to \textcircled{3}, and obtaining an optimal beam domain precoder of each user;
(3) in the design for maximizing the system traversal and the rate upper bound, the system traversal and the rate upper bound are obtained by utilizing a Johnson's inequality of the system traversal and the rate, an expression includes the beam matrix, the beam mapping matrix of each user, the beam domain precoder, the beam domain statistical channel information of each user, the design problem of the spatial domain precoder is transformed into the design problem of the beam domain precoder, and the iterative design of the beam domain precoder includes following steps:
\textcircled{1} initializing the beam domain precoder of each user, to satisfy a power constraint;
\textcircled{2} obtaining, by utilizing an MM algorithm framework, a convex substituting function of the system traversal and the rate upper bound under a current iteration;
\textcircled{3} solving, by utilizing a Lagrange multiplier means, a convex problem of the current iteration; and
repeating, until reaching a preset number of iterations or a pre coding convergence, Steps \textcircled{2} to \textcircled{3}, and obtaining an optimal beam domain precoder of each user.

7. The skywave massive MIMO beam structure precoding-based transmission method according to claim 1, wherein a transmission of the downlink signal with the user implemented by the beam domain precoder generated according to the design includes following steps:
(1) generating, by multiplying the beam domain precoder with data symbols transmitted by the beam domain precoder, a low dimensional beam domain transmitted signal;
(2) obtaining, by multiplying the beam mapping matrix with the low dimensional beam domain transmitted signal, a user beam domain transmitted signal;
(3) obtaining, by overlaying the beam domain transmitted signal of each user, beam domain transmitted signals of all users; and
(4) generating, by multiplying the beam domain matrix with the beam domain transmitted signals of all users, a spatial domain transmitted signal.

8. The skywave massive MIMO beam structure precoding-based transmission method according to claim 6, wherein Step (4) is effectively implemented by utilizing a Chirp-z transform.

9. A skywave massive MIMO beam structure precoding-based transmission system, comprising a skywave massive MIMO communication base station and a plurality of users, wherein the skywave massive MIMO communication base station includes a massive antenna array, an operating carrier frequency with a short wave band ranging from 1.6 MHz to 30 MHZ, and the base station transmits signals to the users through an ionospheric reflection.

10. A skywave massive MIMO beam structure precoding-based transmission system, comprising a base station and a plurality of users, wherein the base station implements the skywave massive MIMO beam structure precoding-based transmission method according to claim 1.
